(19) United States
(12) Patent Application Publication
(10) Pub. No.: US 2014/0245066 A1
(43) Pub. Date: Aug. 28, 2014

(54) SCAN DIAGNOSIS ANALYSIS USING CALLOUT CLUSTERING

(71) Applicant: Lionel J. Riviere-Cazaux, Austin, TX (US)

(72) Inventor: Lionel J. Riviere-Cazaux, Austin, TX (US)

(21) Appl. No.: 13/778,546

(22) Filed: Feb. 27, 2013

(51) Int. Cl. G06F 11/07

(52) U.S. Cl. CPC G06F 11/079
USPC 714/37

(57) ABSTRACT

A scan diagnosis analysis method and system therein utilizes clusters of scan failure callouts. According to at least one embodiment of the present disclosure, better detection of non-random failures can be enabled by utilizing a database of scan failure callouts and forming meaningful clusters or sets of scan failure callouts. Clusters can be formed by rules allowing combination of scan failure callouts having common or connected network locations or layout features.

### FIELD OF THE DISCLOSURE

This disclosure generally relates to electronic devices and in particular to a method for analyzing failures associated with electronic device.

### BACKGROUND

Design For Test (DFT) techniques are commonly implemented at electronic devices and can be implemented using scan testing. Scan testing uses scan chains, wherein a predetermined data pattern is scanned-into a chain of flip-flops and presented to a set combinational logic. Results from the combinational logic are latched into the scan chain before being serially scanned out, where the results, e.g., the output data, can be monitored and compared against expected data. A failure is determined when the output data from the scan chain does not match the expected data.

### BRIEF DESCRIPTION OF THE DRAWINGS

The present disclosure may be better understood, and its numerous features and advantages made apparent to those skilled in the art by referencing the accompanying drawings.

FIG. 1 illustrates an example scan chain in accordance with at least one embodiment of the present disclosure.

FIG. 2 illustrates an example method flowchart of forming clusters of scan failures in accordance with at least one embodiment of the present.

FIG. 3 illustrates an example of combining scan failure callouts with common network locations in accordance with at least one embodiment of the present disclosure.

FIG. 4 illustrates an example of combining scan failure callouts with a common short in accordance with at least one embodiment of the present disclosure.

FIG. 5 illustrates an example of combining logic equivalent scan failure callouts in accordance with at least one embodiment of the present disclosure.

FIG. 6 illustrates a flowchart of forming a subset of clusters for analysis in accordance with at least one embodiment of the present disclosure.

FIG. 7 illustrates example scan failure callouts in different areas within a die in accordance with at least one embodiment of the present disclosure.

### DETAILED DESCRIPTION

An error condition at an electronic device, such as an integrated circuit die, is detected when for a given test input sequence, such as a sequence of bits scanned into a scan chain (an input vector), the resulting test output sequence, such as bits scanned from the test chain (an output vector), does not match an expected output test vector. When this occurs, the output vector is said to have an error signature, e.g., a particular state that does not match an expected value. A particular error signature can be the result of one or more error conditions existing at the electronic device being tested, where error condition can be identified by failure callouts.

The term “scan diagnosis” as used herein is intended to refer to the methodology that evaluates the properties (type, location, severity, and the like) of electrical faults that can cause the observed error signatures.

The term “failure callout” as used herein is intended to refer to information that identifies a network location of an electronic device identified by the scan diagnosis, wherein there can be one or more failure callouts for each output vector having an error signature. According to an embodiment, each failure callout can contain information related to where a particular error occurred at the electronic device. For example, a failure callout can identify a network location or physical location where an error occurs.

The term “network location” as used herein, refers to electrical and logic network locations associated with a device structure. Examples of such network locations can include active and passive devices including individual transistors, logic cells comprising multiple transistors, interconnects (nets) between devices, and the like

The term “layout feature” as used herein, is intended to refer to network locations or netlist locations and can include descriptive features of failure callouts which may be mappable to a physical device, net, pin, interconnect or the like. The terms “layout feature” and “network location” may be used interchangeably herein and are typically associated with corresponding identifiers that can be used in the generation of the failure callout.

According to an embodiment, callout information identifying a failure location can include one or more of a cell ID for a device associated with the error, a net ID associated with the error, a pin ID of the device associated with the error, a physical location where an the error is diagnosed, e.g., Cartesian coordinates, and the like. As multiple output vectors associated with the error signatures are accumulated for corresponding input vectors, failure callouts can be identified using scan diagnosis and accumulated into a database. The database can represent network locations from one or more die, wafers, devices, and the like where errors have occurred, or are likely to have occurred. While the testing of devices as discussed herein is accomplished using scan diagnosis analysis, wherein input vectors are provided to a scan chain, and output vectors are provided by the scan chain, it will be appreciated that other types of testing can be used to determine failure callouts.

A scan diagnosis data analysis method according to at least one embodiment of the present disclosure can enable better detection of non-random failures by utilizing the database of scan failure callouts and forming meaningful clusters, which are sets of network locations or locations that are related to each other by virtue of having connected network locations or being proximate to each other, to identify failures at a cluster-level, as opposed to a lower level, such as at an individual device level. Connectivity defining clusters can be direct or bounded. For example, pin A can be connected to pin B through net C (direct) or pin A can be connected to pin B by going through less than N number of logic gates (bounded).

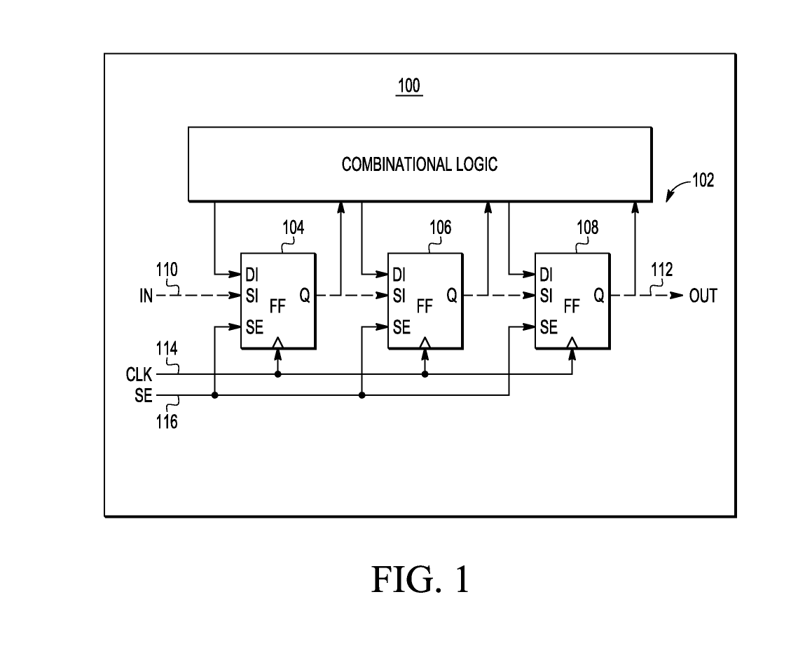

According to an embodiment, an initial cluster is formed with one or more network locations or layout features identified by a single failure callout. The network locations of a subsequent failure callout (a new failure) are added to this initial cluster, if the new failure callout has network locations connected to network locations in the initial cluster. If none of the callout network locations of the new failure callout are connected to any of the declared cluster, a new cluster is declared and the failure callout locations are added to this new cluster. If a new callout is found to have connectivity to several clusters, it means that these clusters are interconnected. Consequently, the interconnected clusters are merged in a single cluster that aggregates all data of these clusters. This process continues until all clusters are found, or until a particular stop criterion is met. The resulting database of clusters for a particular device, such as a die or a wafer containing die, is then compared to the data base of clusters for other similar devices to determine if there is a commonality to the clusters, which when present indicates a likelihood of a non-random failure across the devices. Various embodiments of the present disclosure will be better understood with reference to FIGS. 1-7 herein.

FIG. 1 depicts a device 100 that includes a typical scan chain 102 used in scan testing of the device 100 according to at least one embodiment of the present disclosure. The device 100 can be a die, a portion of a die, a logic block, packaged die, or the like. The device 100 includes a scan chain input 110 for receiving a scan-in data stream, e.g., an input vector, and a scan chain output 112 for outputting the scan-out data stream, e.g., an output vector. The device 100 operates in normal operational mode when the scan chain is disabled, e.g., scan enable signal 116 is low. When the scan enable signal 116 is high, the device 100 is in a scan test mode.

A scan input vector is typically a predetermined pattern of binary data forming a string of test bits for exercising the combinational logic of device 100. In scan test mode, the scan flip-flops are interconnected in a sequential chain. Scan data is clocked in, bit by bit, through the scan chain 102 using a scan clock 114. In the example of FIG. 1, the clocked scan data stream propagates into a first flip-flop 104. In response to being in scan mode, e.g. the scan enable (SE) pin receives an asserted scan enable signal, the scan input (SI) of the flip-flop 104 is selectively latched and routed to the output (Q) of flip-flop 104, which is connected to both the scan input of the next flip-flop 106 of the chain and to the combination logic. As the flip-flop 106 is clocked, the scan input of flip-flop is selectively latched and routed to the output Q of flip-flop 106, which is then routed to the next flip-flop 108 accordingly. Once all bits of an input vector are propagated and stored at their corresponding flip-flop of the scan chain, the scan enable signal is negated to allow data at the input DI of each flip-flop to be latched, where the data provided to the DI inputs is provided by the combinational logic, and therefore indicative of its operation. As the next input vector is clocked into the scan chain, after input SE is asserted, the output vector stored in the scan chain that is based upon the combinational logic and the previous input vector is clocked-out through scan chain output 112. The resulting scan-out data, output vector, is monitored and compared with expected data. A scan failure is detected when a mismatch occurs. Each scan failure can be associated with one or more failure callouts, each of which identifies a suspected error location. Each failure callout typically contains information related to a network location or layout feature, such as a cell ID, where the failure occurred. Evaluation of output vectors and generation of error callouts can be accomplished through the use of commercially available tools, such as Cadence Design Systems' Encounter® Diagnostics and Mentor Graphics' Tessent® Diagnosis.

As multiple instances of device 100 are scan tested, a database of scan failure callouts can be formed. For example, device 100 may be a die on a wafer. As each die site on the wafer is tested, scan failure callouts can be accumulated into a scan failure callouts database for each die of the database. The scan testing can be similarly extended to multiple wafers, forming an even larger scan failure callout database.

Volume scan diagnosis is the analysis or diagnosis of many die. The callout database of scan failures from many die can be very large and present difficulties in extracting meaningful information from the data. For instance, low-level or non-prominent repeating failures can be difficult to detect because they may appear so infrequently, or appear within a region (e.g., they do not occur at a fixed specific location), that they appear as random failure callouts. An example of this would be the case where multiple dies have an actual defect at a specific location that is marginal in nature so that it will manifest itself as an actual error only for some processing flows. Thus, because of die to die variability, test repeatability issues, test sequencing and/or scan pattern marginality, the observed fails in the output vector will vary. Because of the observation variation, the scan diagnosis will also vary. The variability in scan failures can also result in false but close to the actual defect callout locations. For example, because of test sequencing, logic aliasing, and other forms of fail variability, diagnosis of a short detected on some die can differ from those of other die. The location of the short can be associated with a particular cell in some die and can be associated with another cell in other die. While the short can be associated with different cells across multiple dies, the actual short can be in a single location. Forming clusters of failure callouts allows better detection of this type of low-level problem that is often obscured by variability in scan failures. In forming clusters, a scan diagnosis process of aggregating many of the callouts into clusters is used to create a smaller, more useful database that indicates regions that fail in a statistically significant manner. Clustering allows different failures in proximity to each other to be combined into a common cluster that corresponds to a region that can be considered a single failure for purposes of comparison between dies. Such clustering of callouts can be used to identify system marginality that is the result of processing or design of device.

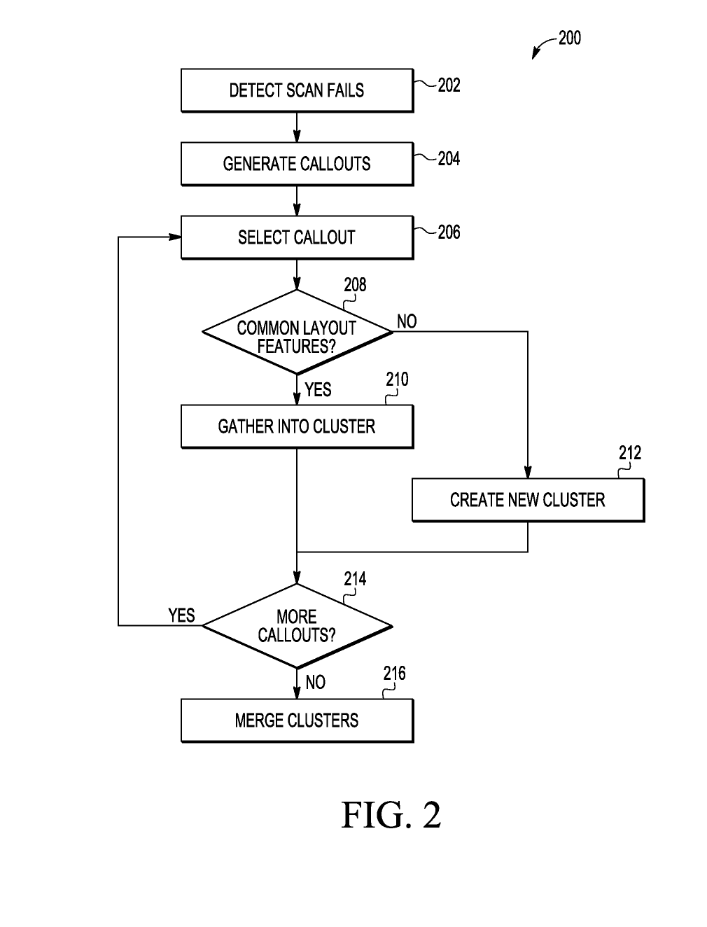

FIG. 2 illustrates a scan diagnosis analysis flowchart 200 for forming clusters of scan failures in accordance with at least one embodiment of the present disclosure. At block 202, scan failures are detected from scan testing devices such as die on a wafer. The devices may also be any scan testable circuits, logic blocks, or the like.

At block 204, callouts are identified for each detected scan failure, wherein each callout represents an actual or suspected error. According to an embodiment, a callout can contain information such as the suspected network locations or layout features, such as a cell ID, net ID, pin ID, or suspected physical location where the error occurred.

At block 206, callouts are selected for cluster evaluation. The term “cluster” as used herein, is intended to mean network locations or layout features associated by connectivity rules (direct, bounded, and the like) with one or more callouts. Larger clusters can be formed from smaller clusters by combining all network locations or layout features from callouts sharing at least one common network location or layout feature. Rules can also be used to form clusters. For example, clusters can be formed by combining callouts having common network locations or layout features, such as common nets, cells, and pins. For another example, clusters can be formed by combining callouts sharing a specified set of cells in common. In some instances, callouts sharing common network locations or layout features may be primarily located in different areas of a die and may not be useful to combine them. Connectivity rules can be applied which allow a callout that has a common network location or layout feature with a cluster to be combined when the callout has a physical location that is proximate to cluster. The proximity can be based upon a length or an area. For example, within a distance that is one-half or one-fourth of a length of a die, or within a specified area, such as less than one-half of the device or die area, less than one-fourth of the device or die area, or an area having a radius of 100 um or less.

At block 208, a callout is compared with existing clusters, and any clustering rules, to determine if a common network location or layout feature is shared between the failure callout and the clusters. If the callout does not have a common network location or layout feature with an existing cluster, it can form a new cluster at block 212. If the callout does have a common network location with an existing cluster, flow proceeds to block 210 which updates the cluster having the common network location by merging the network locations or layout features of the new callout into the existing cluster. Thus, at block 210, callouts are gathered into clusters which share common network locations or layout features. Rules can be used at block 210 as to how to update clusters with information from callouts sharing common network locations or layout features. For instance, the size or number of callout combinations may be limited so that clusters do not grow too large or complex. For example, the number of clusters can be limited to a specified number, which can be programmable. In another example, certain nets or cells or other network locations or layout features may be selectively included or excluded when the cluster is updated.

At block 212, new clusters are created from callouts not having an overlapping existing cluster, or from callouts not meeting a specific clustering rule. For example, a first callout or callouts that do not share a common network location or layout feature with an existing cluster can form a new cluster. Once a cluster is created, it can be added to a cluster database. The cluster can also be compared with other clusters to determine if it should be merged with any of the other clusters.

At block 214, if more callouts exist, the process continues at block 206 where the next callout is evaluated and selected. If no further callouts need to be processed, then the cluster can be merged with other clusters at block 216 as required and deposited into a cluster database.

At block 216, clusters can be compared with other clusters to determine if they have common network locations or layout features. A cluster sharing a common network location or layout feature with another cluster can be merged into one cluster. Rules can be used to determine how to merge or combine clusters. For example, clusters can be merged by only combining clusters sharing common nets. For another example, clusters merged by combining clusters sharing common network locations or layout features can be limited to the number of combinations or area of the combined cluster. The cluster database or collection of clusters can be used to analyze one or more die or devices based on one or more clusters or sets of failure callouts.

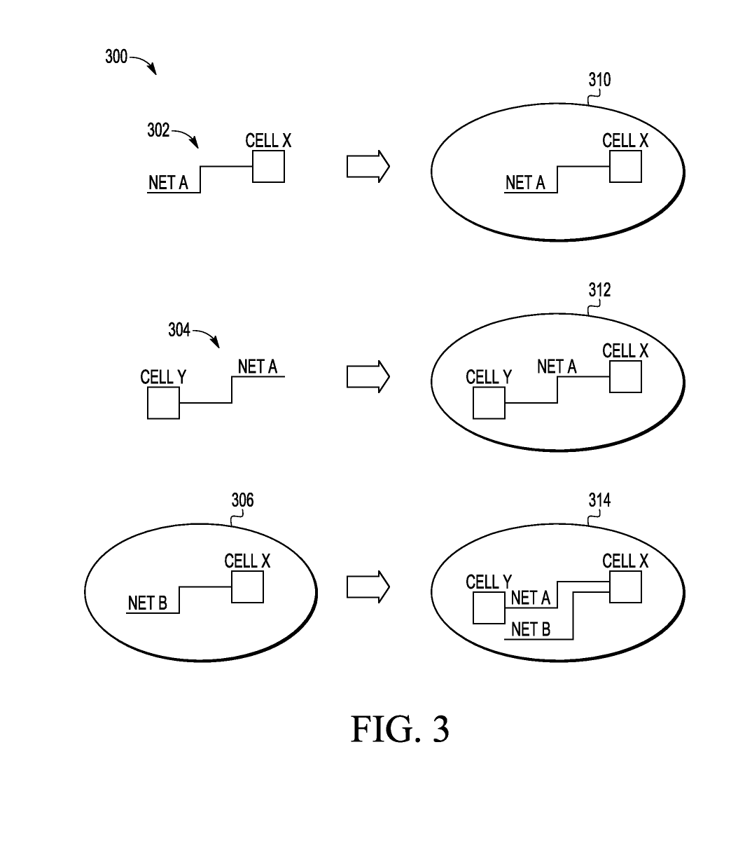

FIG. 3 illustrates an example of a clustering technique 300 in accordance with at least one embodiment of the present disclosure in which clusters are formed by combining callouts sharing a common net or cell ID. In FIG. 3, a first callout 302, identified by a net (Net A) and a cell (Cell X), is illustrated that is not associated with any existing clusters is formed into cluster 310. A next call out, callout 304, is determined to have a net (Net A) in common with cluster 310, thus callout 304 is combined or merged with cluster 310, forming a larger cluster 312. Also in this example, a cluster 306 is determined to have a cell (Cell X) in common with cluster 312, and therefore cluster 306 and cluster 312 are combined to form a larger cluster 314. When the larger cluster 314 is formed, clusters 306 and 312 can be deleted or ignored. As clusters are formed, they can be accumulated into a cluster database.

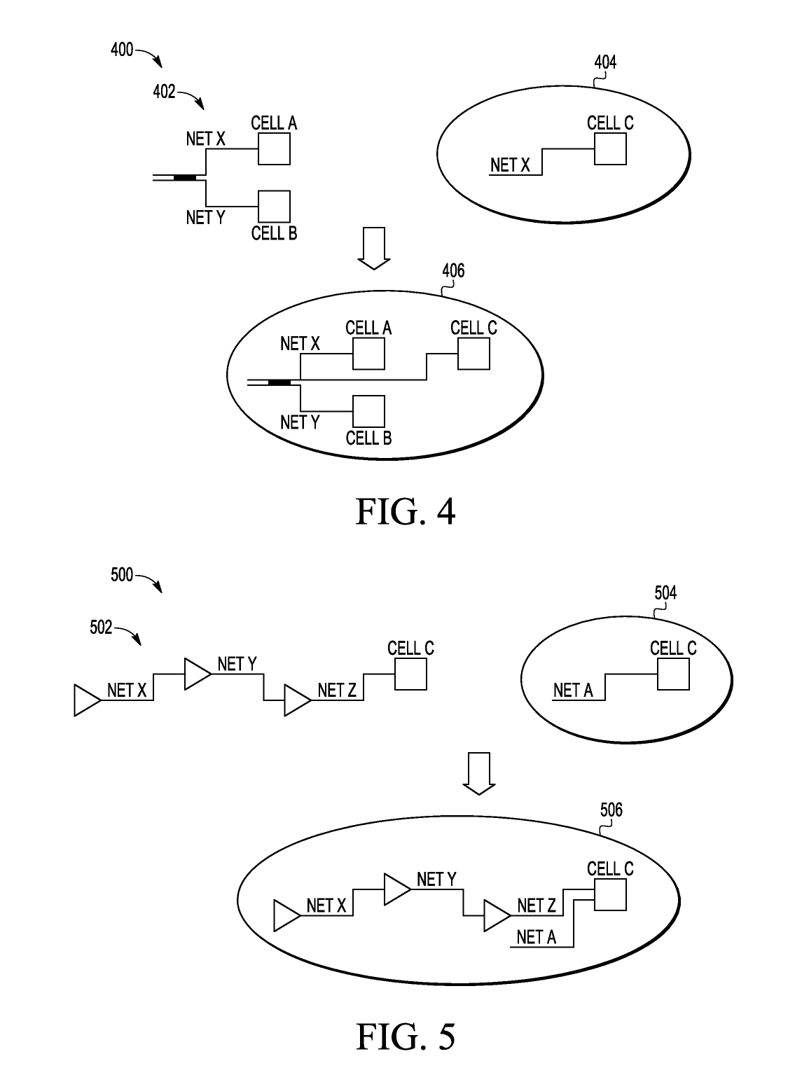

FIG. 4 illustrates an example of a clustering technique 400 in accordance with at least one embodiment of the present disclosure. In the example of FIG. 4, a callout 402 includes two nets and two cells, such as would result from a short between Net X and Net Y. Since an existing cluster 404 contains a net in common with a net in the callout 402, namely Net X, the callout 402 is merged with the cluster 404 forming a larger cluster 406.

FIG. 5 illustrates an example of a clustering technique 500 in accordance with at least one embodiment of the present disclosure in which clusters are formed by combining an equivalent callout 502 with a cluster 504 sharing a common cell. The term “equivalent callout” as used herein, refers to a callout including a repeated string of logic cells that can be represented logically by a single cell. Typically, scan diagnosis cannot distinguish where an error condition exists within the string of such cells. Examples of repeated cells in an equivalent callout include a string of repeated inverters or buffers, and the like. In the example of FIG. 5, the equivalent callout 502 includes a string of buffers that can be represented as a single buffer. The string of buffers in the equivalent callout 502 connects to a cell, Cell C. Since the cluster 504 contains a cell in common with a cell in the equivalent callout 502, the equivalent callout 502 is merged with the cluster 504 forming a larger cluster 506. The larger cluster 506 now contains the string of buffers of the equivalent callout 502 along with the elements of the cluster 504.

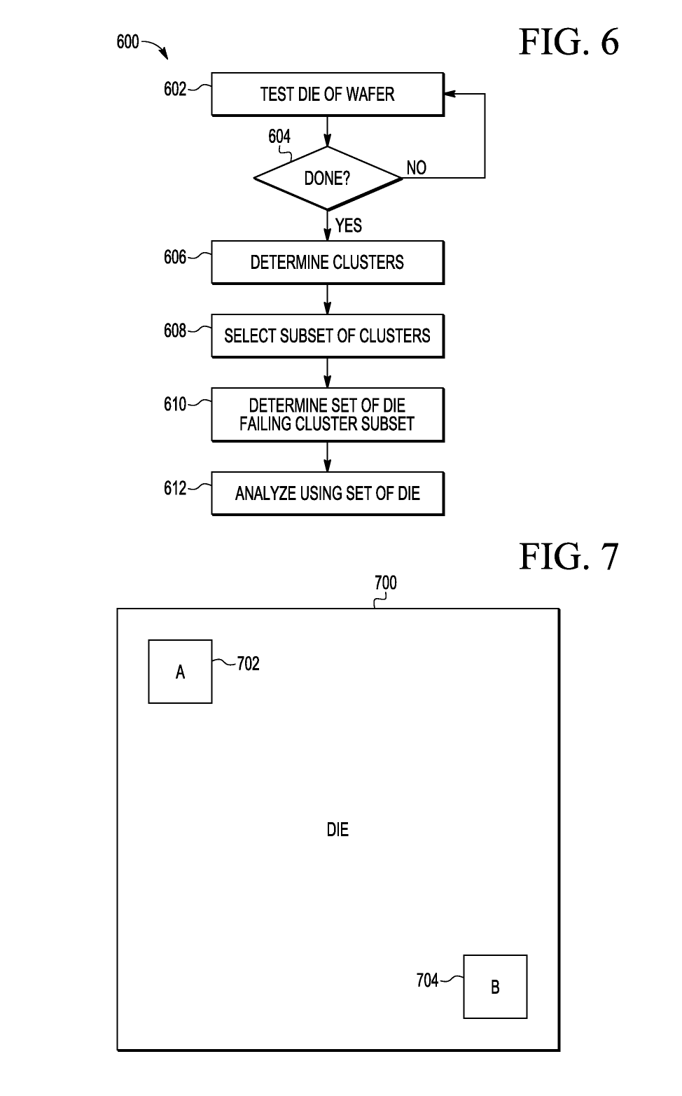

FIG. 6 illustrates a scan diagnosis analysis flowchart 600 of selecting a subset of formed clusters of scan failures for further analysis in accordance with at least one embodiment of the present disclosure. At block 602, a die of a wafer is scan tested. As the die is tested, scan failure callouts denoting suspected errors associated with the die's scan failures are collected in a failure callout log for that die. At block 604, if all of the die on the wafer have not been tested, then the next die is tested at block 602. When all of the die on the wafer have been tested, the flow continues on to block 606.

At block 606, the scan failure callout logs of each die are diagnosed to determine failure clusters as described above, which are maintained in a cluster failure callout for that die.

At block 608, a subset of clusters can be selected for further analysis. In some embodiments, a Pareto distribution can be used to select a set of the top or highest failing clusters across all die. For example, those clusters that occur most often across the die sample set, e.g., the top 10 percent of failing clusters in the database, e.g., the device population, can be selected as a subset for analysis. In another example, a specific number of top failing clusters in the database can be selected as a subset for analysis. In some embodiments, a set the clusters formed by a specified number or range of numbers of callout combinations can be used as the basis for analysis. For example, all clusters formed from a certain number of individual failure callouts can be selected for analysis. In another example, a portion of the smallest clusters in the database can be selected as a subset for analysis, or a as subset for exclusion of analysis. In yet another example, clusters formed within a range of callouts, as greater than four failure callouts and less than 16 failure callouts, can be selected as a subset for analysis. In some embodiments, the selection of a subset of clusters from the cluster database is programmable.

The manner of determining whether die have a common failure cluster can vary. For example, according to an embodiment, two die have a common failure cluster only if the exact same cluster is associated with each die, e.g., each die has a cluster with the exact same network locations or layout features. According to another embodiment, two die have a common cluster when the failure cluster of one die has a sufficient amount of overlapping callouts. For example, if two callouts overlap by 50% or by a fixed number of callouts.

At block 610, the dies failing a selected subset of clusters is determined and analyzed as block 612. By analyzing a reduced number of dies based upon selected clusters, seldom occurring, but non-random failure mechanisms can be identified. For example, a selected subset of cluster can include all of the clusters containing a common short, or a region of a die where a marginal design rule has been implemented for a particular process. The resulting failure mechanism can then be analyzed for root cause of the shorts. For example, this analysis can lead to identification of processing marginalities, design marginalities, mask defects, and the like. Once the set of die are identified as failing for the subset of clusters, root cause analysis can occur. For example, during the analysis the actual source of a short or multiple shorts can be determined.

While callouts sharing common network locations or layout features can be combined to form a cluster, or combined to form larger clusters, in other embodiments, callouts sharing a common network location or layout feature can be prevented from being combined in response to network features being separated by a large distance. For example, FIG. 7 illustrates example scan failure callouts in different areas within a die 700 in accordance with at least one embodiment of the present disclosure. In this example, block A 702 is a callout or cluster which is a significant distance from block B 704, which is a callout sharing a common network location or layout feature (not specifically illustrated). This separation can be used as a callout exclusion criteria in order to accelerate the cluster parsing process. Conversely, rules can be applied which allow a callout that has a no common network location or layout feature with a cluster to be combined when the callout has a physical location proximate the cluster as described in FIG. 2 above. In an example, a first bounding region containing all nets and cells listed in a cluster can be compared with a second bounding region containing the nets and cells of a callout. It will be appreciated that a bounding region can be represented in a plurality of Cartesian coordinates and the like. If the first and second bounding regions intersect, then the callout can be merged with the cluster. In another example, all cells listed in a cluster can be contained in a bounding region having a centroid. If a callout cell is less than X number of micrometers from the cluster's centroid, then the callout can be merged with the cluster.

It will be appreciated that various novel embodiment are disclosed herein. In a first aspect, a method can include determining that a first failure callout has a common layout feature with a first set of failure callouts that includes at least one failure callout, adding layout features of the first failure callout to the first set of failure callouts, and analyzing a first device in response to having a particular set of failure callouts.

In one embodiment of the first aspect, the first failure callout is based on a first scan failure, the first set of failure callouts is based on one or more scan failures. In another embodiment, each of the first failure callout and the first set of failure callouts include a plurality of layout features including a net and a cell. In a further embodiment the method includes analyzing a plurality of die having the particular set of failure callouts, where the plurality of die includes the first device.

In another embodiment of the first aspect, the method includes determining that the first failure callout has the common layout feature with the first set of failure callouts includes determining that the first failure callout has a physical location proximate to the first set of failure callouts. In a particular embodiment, the proximate location of the common layout feature to the first set of failure callouts is one-half of a length of the device or less. In a more particular embodiment, the proximity location of the common layout feature to the first set of failure callouts is one-fourth of a length of the device or less. In an even more particular embodiment, the proximity location of the common layout feature to the first set of failure callouts is 100 um or less.

In a second aspect, a method can include generating scan failure callouts based on scan failures, wherein each scan failure callout includes one or more layout features, forming clusters of scan failure callouts by combining scan failure callouts having one or more common layout features, and identifying devices having overlapping clusters of scan failure callouts.

In one embodiment of the second aspect, the layout features include a net and a cell. In another embodiment, forming clusters of scan failure callouts by combining scan failure callouts is limited to a specified number of clusters. In yet another embodiment, combining scan failure callouts having common layout features is in response to using a physical location of the scan failure callout to determine whether to combine scan failure callouts.

In a further embodiment of the second aspect, the method includes selecting a specified portion of the clusters, and evaluating devices failing the specified portion of the clusters. In a particular embodiment, the specified portion of the clusters is determined by a top 10% of failure clusters in a device population. In a more particular embodiment, the specified portion of the clusters is programmable.

In a third aspect, a scan diagnosis analysis system can include a data processor to determine that a first failure callout has a common layout feature with a first set of failure callouts that includes a plurality of failure callouts, merge layout features of the first failure callout with the first set of failure callouts in response to determining the first failure callout has the common layout feature, and identify one or more die based on one or more sets of failure callouts.

In one embodiment of the third aspect, the layout feature includes at least one of a net and a cell. In another embodiment, the one or more die comprise one or more die on a common wafer. In still another embodiment, the system is to merge the layout features of the first failure callout with the first set of failure callouts in response to determining that the first failure callout has the common layout feature and that the first failure callout is proximate to the first set of failure callouts. In a further embodiment, the first failure callout is proximate to the first set of failure callouts based upon a distance between the failure callout and the first set of failure callouts.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof. For example, one skilled in the art would appreciate that a data processing system, such as a computer having an instruction based data processor, can be used to implement the analysis described herein.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
determining that a first failure callout has a common layout feature with a first set of failure callouts that includes at least one failure callout;
adding layout features of the first failure callout to the first set of failure callouts; and
analyzing a first device in response to having a particular set of failure callouts.

2. The method claim 1, wherein the first failure callout is based on a first scan failure, the first set of failure callouts is based on one or more scan failures.

3. The method claim 1, wherein each of the first failure callout and the first set of failure callouts comprise a plurality of layout features including a net and a cell.

4. The method of claim 1, further comprising analyzing a plurality of die having the particular set of failure callouts, where the plurality of die include the first device.

5. The method of claim 1, wherein determining that the first failure callout has the common layout feature with the first set of failure callouts includes determining that the first failure callout has a physical location proximate to the first set of failure callouts.

6. The method of claim 5, wherein the proximate location of the common layout feature to the first set of failure callouts is one-half of a length of the device or less.

7. The method of claim 5, wherein the proximity location of the common layout feature to the first set of failure callouts is one-fourth of a length of the device or less.

8. The method of claim 5, wherein the proximity location of the common layout feature to the first set of failure callouts is 100 um or less.

9. A method, comprising:
generating scan failure callouts based on scan failures, wherein each scan failure callout includes one or more layout features;
forming clusters of scan failure callouts by combining scan failure callouts having one or more common layout features; and
identifying devices having overlapping clusters of scan failure callouts.

10. The method of claim 9, wherein the layout features include a net and a cell.

11. The method of claim 9, wherein forming clusters of scan failure callouts by combining scan failure callouts is limited to a specified number of clusters.

12. The method of claim 9, wherein combining scan failure callouts having common layout features is in response to using a physical location of the scan failure callout to determine whether to combine scan failure callouts.

13. The method of claim 9, further comprising:
selecting a specified portion of the clusters; and
evaluating devices failing the specified portion of the clusters.

14. The method of claim 13, wherein the specified portion of the clusters is determined by a top 10% of failure clusters in a device population.

15. The method of claim 13, wherein the specified portion of the clusters is programmable.

16. A scan diagnosis analysis system comprising a data processor to:
determine that a first failure callout has a common layout feature with a first set of failure callouts that includes a plurality of failure callouts;
merge layout features of the first failure callout with the first set of failure callouts in response to determining the first failure callout has the common layout feature; and
identify one or more die based on one or more sets of failure callouts.

17. The scan diagnosis analysis system of claim 16, wherein the layout feature includes at least one of a net and a cell.

18. The scan diagnosis analysis system of claim 16, wherein the one or more die comprise one or more die on a common wafer.

19. The scan diagnosis analysis system of claim 16, wherein the system is to merge the layout features of the first failure callout with the first set of failure callouts in response to determining that the first failure callout has the common layout feature and that the first failure callout is proximate to the first set of failure callouts.

20. The scan diagnosis analysis system of claim 19, wherein the first failure callout is proximate to the first set of failure callouts based upon a distance between the failure callout and the first set of failure callouts.
